(19) United States
(12) Patent Application Publication
(10) Pub. No.: US 2004/0085457 A1
(43) Pub. Date: May 6, 2004

(54) Reviewing stored images

(76) Inventors: Miles K. Thorland, Ft. Collins, CO (US); Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/284,356

(22) Filed: Oct. 31, 2002

(51) Int. Cl. H04N 5/225

(52) U.S. Cl. 348/220.1

(57) ABSTRACT

A user interface and related method of use provides enhanced functionality for input controls on a digital camera. Activating the input controls enables a user to individually display a given digital image of a plurality of stored digital images and then jump non-sequentially to another digital image. The user interface also or alternatively enables a user to use the input controls to zoom in and out of the given digital image.

### CROSS-REFERENCES TO RELATED APPLICATIONS

The present invention is related to pending application Ser. No. ______ filed ______, and entitled “IMAGE BROWSING USER INTERFACE APPARATUS AND METHOD”, by Stavely et al., designated by assignee docket number 10019757-1. The present invention is also related to pending application Pub. No. US 2002/0063902 A1 filed Jan. 18, 1902, and entitled “APPLIANCE AND METHOD FOR NAVIGATING AMONG MULTIPLE CAPTURED IMAGES AND FUNCTIONAL MENUS”, by Dow et al.

### BACKGROUND

Improvements in user interface designs enable everyone—young and old—the ability to quickly and easily operate a complex device such as a digital camera. Many digital cameras are provided with user interface features such as a video screen and controls. The video screen is typically a liquid crystal display (LCD) located on the back of the digital camera and is used to display feedback information to a user such as instructions, live images, and stored images. The controls are typically push buttons, switches, and dials located on the top, sides, front, or back of the digital camera and are used to turn the digital camera on and off, to control image capturing functions, to navigate stored images, and to switch between operating modes. There are several modes in which a digital camera typically operates including start-up mode, menu mode, capture mode, and review mode.

Advances in digital camera technology have led to both decreases in the size of camera bodies and to increases in image storage capacity. Unfortunately, however, the downsizing of digital camera bodies result in very little surface area to locate the many control buttons and switches that are typically provided. Such controls often serve some function in one operating mode, but serve no function in another operating mode. For example, a four-way rocker switch may provide up-down-left-right functions in the menu mode but may be partially useless in the review mode. Moreover, the upsizing of memory capacity yields dozens if not hundreds of stored images through which a user must painstakingly scroll in review mode. Due to the vast number of keystrokes required and due to the time needed to regenerate each image in succession, scrolling sequentially through multitudes of images can be annoyingly time consuming.

### SUMMARY

One embodiment of the present invention may comprise a digital camera user interface having a display for displaying a plurality of images, and a navigational control in communication with the display. The navigational control includes a first and second pair of opposing directional modes. The first pair of opposing directional modes is provided for sequentially scrolling through the plurality of images. The second pair of opposing directional modes is provided for at least one of the following functions: controlling zoom functionality of the plurality of images, and jumping non-sequentially from one image of the plurality of images to another image of the plurality of images to display the another image.

Another embodiment of the present invention may comprise a method of reviewing stored images on a digital camera. The method includes displaying one image of a plurality of stored images, and navigating the plurality of stored images. Navigating includes at least one of the following: jumping from the one image to another image of the plurality of stored images, whereby the another image is then displayed; and zooming the one image by activating a pair of opposing directional input controls.

### BRIEF DESCRIPTION OF THE SEVERAL VIEWS OF THE DRAWINGS

FIG. 1 is a block diagram of a digital camera in accordance with an exemplary embodiment of the present invention.

FIG. 2 is a diagram of an organizational scheme for digital images stored in a memory of a digital camera in accordance with an exemplary embodiment of the present invention.

FIG. 3 is an illustration of a digital camera user interface in accordance with an exemplary embodiment of the present invention.

FIGS. 4A and 4B comprise a flow chart of the operation of the user interface of the digital camera in accordance with an exemplary embodiment of the present invention.

FIGS. 5A and 5B comprise a flow chart of the operation of the user interface of the digital camera in accordance with another exemplary embodiment of the present invention.

### DETAILED DESCRIPTION OF THE INVENTION

Generally shown in the figures, a digital camera and method of operating same is presented in accordance with exemplary embodiments of the present invention. Improved digital camera operation is facilitated by providing an image browsing user interface that optimizes the functionality of existing controls. For example, quick and easy navigation among and display of individual digital images may be enabled by an image browsing user interface that scrolls through and jumps non-sequentially between stored digital images. Alternatively, the functions of two or more different controls used in different operating modes may be combined into one set of controls, thereby accommodating smaller digital camera designs. The terminology “image” and “digital image” are used interchangeably throughout the following description.

The present invention is related to pending application Ser. No. ______ filed ______, and entitled “IMAGE BROWSING USER INTERFACE APPARATUS AND METHOD”, by Stavely et al., designated by assignee docket number 10019757-1. The present invention is also related to pending application Pub. No. US 2002/0063902 A1 filed Jan. 18, 1902, and entitled “APPLIANCE AND METHOD FOR NAVIGATING AMONG MULTIPLE CAPTURED IMAGES AND FUNCTIONAL MENUS”, by Dow et al. The above listed cross-references are assigned to the assignee of the present invention and are incorporated by reference herein.

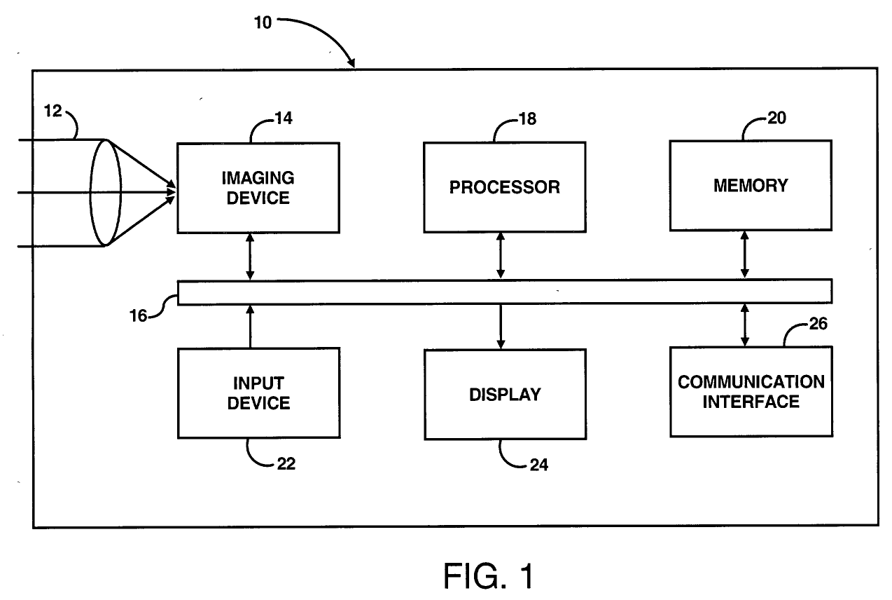

Referring now in detail to the figures, there is shown in FIG. 1 a block diagram of a digital camera 10 in accordance with an exemplary embodiment of the present invention that is used in accordance with a method according to another exemplary embodiment of the present invention. The digital camera 10 is capable of video and/or still image generation and generally includes an optical system 12 in optical communication with a photosensor 14 that communicates to other components of the digital camera 10 via a data bus 16. The data bus 16 provides communication between the photosensor 14, a controller, microprocessor, or processor 18, a memory 20, an input controls 22, a display 24, and a communication interface 26.

The optical system 12 may include a lens or series of lenses, a viewfinder, an aperture, shutter, and the like (none shown). The optical system 12, or portions thereof, may be an integral part of the digital camera 10 or may be separately attached. In any case, the optical system 12 is used to direct radiant energy into the digital camera 10 by focusing, isolating, or framing a selected subject scene, or view of the world from which emanates or reflects rays of energy. In other words, the optical system 12 provides a conduit into which rays of light are received and through which the rays of light travel to the inside of the digital camera 12 and impinge upon the photosensor 14.

The photosensor 14 converts optical images impinged thereon by the optical system 12 into raw digital data, or converted image(s), representative of the optical image impinged thereon. This digital data may be enhanced by the processor 18 and may be stored in the memory 20 via the data bus 16 and later used to produce a display image on the display 24. The phrases digital data, digital image data, digital images, converted images, and the like are to be considered synonymous and are used interchangeably herein. In a typical implementation, the photosensor 14 includes a charge-coupled device (CCD), complimentary metal oxide semiconductor (CMOS), or the like. The photosensor 14 may further include an analog-to-digital converter (A/D), a gain control, and a digital signal processor (DSP) (none shown). Thus, the term photosensor is to be interpreted broadly to encompass any device capable of performing the same or similar function as a CCD, CMOS, or the like.

The data bus 16 may be a multiplex cabling system, a separate bus, multiple control lines, or the like, and is used to transfer control, timing, and data signals between the various components of the digital camera 10 including the processor 18. The processor 18 may be a microprocessor (MPU) or similar type of central processing unit (CPU). The memory 20 may include, but is not limited to, cache, ROM, PROM, EPROM, EEPROM, flash, SRAM, DRAM, and the like. The memory 20 may include a single memory device or multiple separate memory devices. The memory 20 may also be used to store any digital camera data such as the camera operating system, program code or operating software, input/output device drivers, user instructions, digital images, meta data, and the like. Thus, the term memory is broad and not relegated merely to one type of memory or one location within the digital camera 10.

The digital camera 10 further includes a user interface that is at least partially defined by the input controls 22 and the display 24. The input controls 22 are used to accept user commands to operate the digital camera 10 and may include buttons, switches, dials, touch screen features, and the like. The display 24 may include a color liquid-crystal-display, gas-plasma discharge display, electroluminescent display, field emission display, and the like.

The communication interface 26 includes hardware and software for communicating with an external device such as a computer or printer (not shown). Power for the digital camera 10 is provided by a power unit such as a battery, an A/C adapter, or the like (not shown).

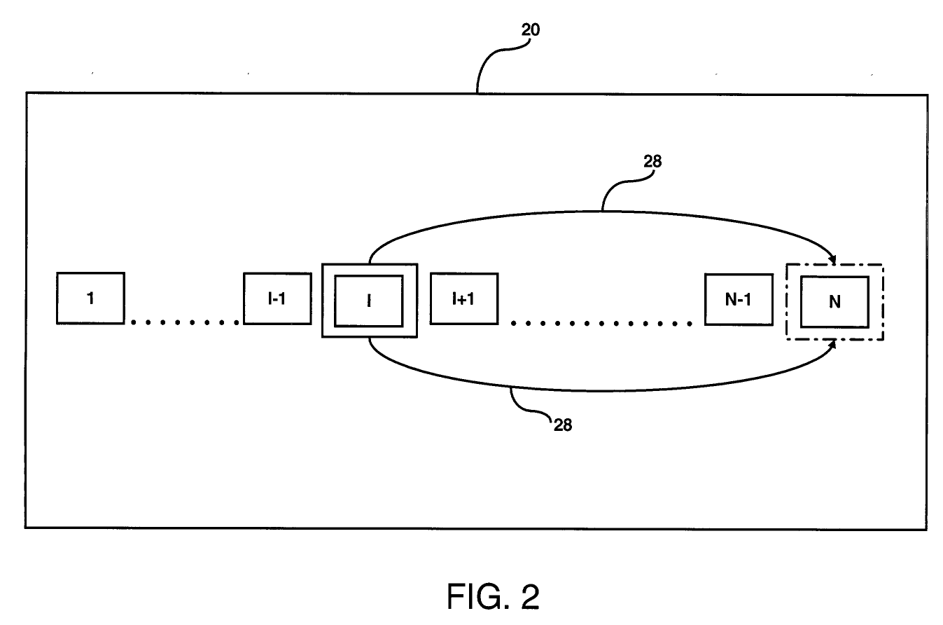

FIG. 2 is a diagram showing an organizational scheme for digital images stored in the memory 20 of the digital camera in accordance with an exemplary embodiment of the present invention. FIG. 2 is a conceptual rather than a literal representation of how images may be organized in the memory of the digital camera. Each digital image is contemplated to be either a single digital image or a representative digital image belonging to a larger group of digital images (not shown). Groups of digital images may include “bursts” of digital images that are captured in a burst capture mode, video sequences captured in video capture mode, time-elapsed photographs, or a collection of arbitrary individual digital images that a user has defined as a group.

Data in a digital image may be other than pictorial type image data. For example, a digital image may include textual instructions or meta data that is associated with respective stored digital images such as date and time taken, image number, image resolution, image size, F-stop setting, shutter speed, aperture setting, flash status, or audio files, and the like. Moreover, a digital image may include a “tombstone” image (not shown), which is usually the default view seen by the user when the digital camera is first placed in review mode and there are no stored images to view. The tombstone is usually the first (or last) view to be presented to the user and contains textual information relating to the stored images such as the quantity thereof, memory remaining, etc. Thus, the terminology “digital image” encompasses not only electronic photographs taken by the camera, but any type of information that the digital camera presents on the display.

Referring still to FIG. 2, there are shown a total quantity of N digital images arranged in series from image 1 to image N to define a series of digital images. As mentioned above, FIG. 2 is a conceptual representation, and the digital images may be stored in memory in any arrangement including an array or any other format without affecting the scope and intent of the present invention. Digital image I represents any given digital image, or set of images, that is currently selected for presentation on the display of the digital camera. Digital image I is intermediate and adjacent digital image I−1 and digital image I+1 such that digital image I+1 is in a sequentially later memory location and digital image I−1 is in a sequentially earlier memory location.

Accordingly, the term sequence is defined herein as either forward or reverse sequence. Furthermore, the order of the series of digital images may be chronological in that the images 1 through N are arranged in the order in which each was captured and stored. Alternatively, one of ordinary skill in the art will recognize that the order may be forced or set by the user, or the order may be set according to a sort routine, such as by memory size, camera settings, and the like.

Still referring to FIG. 2, previously a user would have to scroll successively from one digital image to the next adjacent digital image while in full or individual image review mode. Now that digital cameras are capable of storing hundreds of digital images, it can be frustrating to a user to scroll consecutively across each and every digital image. Such a limitation is especially cumbersome since a digital camera can take several seconds to assemble each digital image for viewing. Thus, it could take several minutes just to arrive at and display the desired digital image in such a series.

Now, however, it is possible to individually display a given image then jump directly to a known or predetermined location such as a “home” position—e.g. the first, last, or middle digital image in a long series. In other words, as shown by arrow 28, this embodiment of the present invention provides the ability to display a given stored image and then jump directly to a predetermined location or image N to display the image N, without having to scroll through images I+1 . . . N−1. Thus, if a user is currently viewing digital image I and wants to quickly and directly jump to the tombstone, the first, or the last digital image, it is now possible to do so with one touch of a button as will be described in detail below.

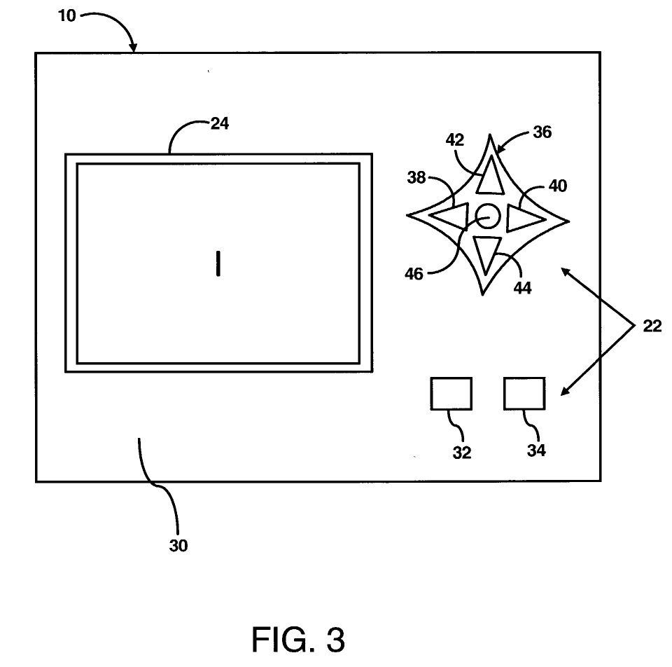

Referring now to FIG. 3, there is shown a user interface of the digital camera according to an exemplary embodiment of the present invention that is defined by the input controls 22 and display 24. Although a digital camera typically includes user interface elements in addition to those shown, only those relevant to this embodiment of the present invention are shown in FIG. 3. The user interface may be located on a back 30 of the digital camera 10, but it is contemplated that the user interface could have portions located in various positions on the digital camera 10 such as on the top, sides, and front (not shown). It is further contemplated that the display 24 could be a separate pivotably mounted or detachable element.

The display 24 is the means by which information including stored digital images, text, icons, and animation are communicated as output to a user. In other words, the display 24 converts digital images stored in memory from electronic bit format to a visual format. Thus, the term digital image as used herein refers both to a set of digital information and an optical image produced on a display device using that set of digital information. For example, in start-up mode, the display 24 enables viewing of a camera logo or camera status information. In menu mode, the display 24 enables viewing of a camera menu. In capture mode, the display 24 enables viewing of live digital images streaming from the photosensor. Finally, in review mode, the display 24 enables viewing of stored digital images transferred from memory as directed by the processor, as represented by digital image I. The display 24 may allow one individual digital image to be viewed at a time or may allow a group of reduced-size “thumbnail” digital images to be viewed simultaneously, or both.

The input controls may include a power button 32, a mode or review button 34, and a navigation control 36. The power button 32 is depressible to turn the digital camera 10 on and off. The review button 34 is depressible to switch between the different modes of the digital camera 10 such as menu mode, capture mode, and review mode.

When the digital camera 10 is placed in review mode by depressing the review button 34, the navigation control 36 is used for at least two alternative purposes including for navigating among the digital images stored in the memory as depicted in FIG. 2, or for zooming in and out of a currently displayed digital image I so as to enlarge or reduce the digital image I or portions thereof. The navigation control 36 may include a pair of opposing horizontal modes composed of a left control 38 and a right control 40, and further includes a pair of opposing vertical modes composed of an up control 42 and a down control 44. The navigation control 36 may further include a “select” functional feature or control when a center portion 46 of the navigation control is pressed. As such, in this embodiment the navigation control 36 can be a five-way rocker switch. The navigation control 36 can also be at least one of the following alternative configurations including: a four-way rocker switch with a separate select control button; two separate horizontal and vertical controls and a select control button; or five separate up, down, right, left, and select control buttons. Furthermore, one of ordinary skill in the art will recognize that the navigation control 36 can additionally or alternatively include any combination of thumbwheels, dials, buttons, switches, and the like without affecting the scope or intent of the present invention.

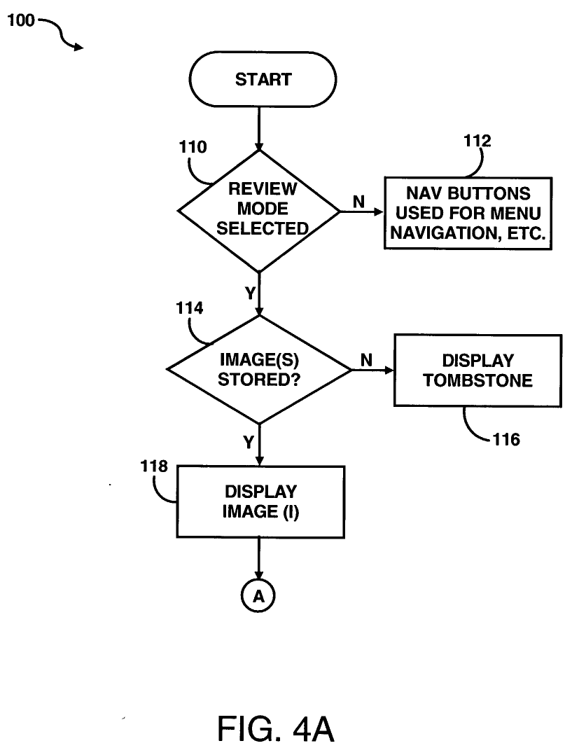

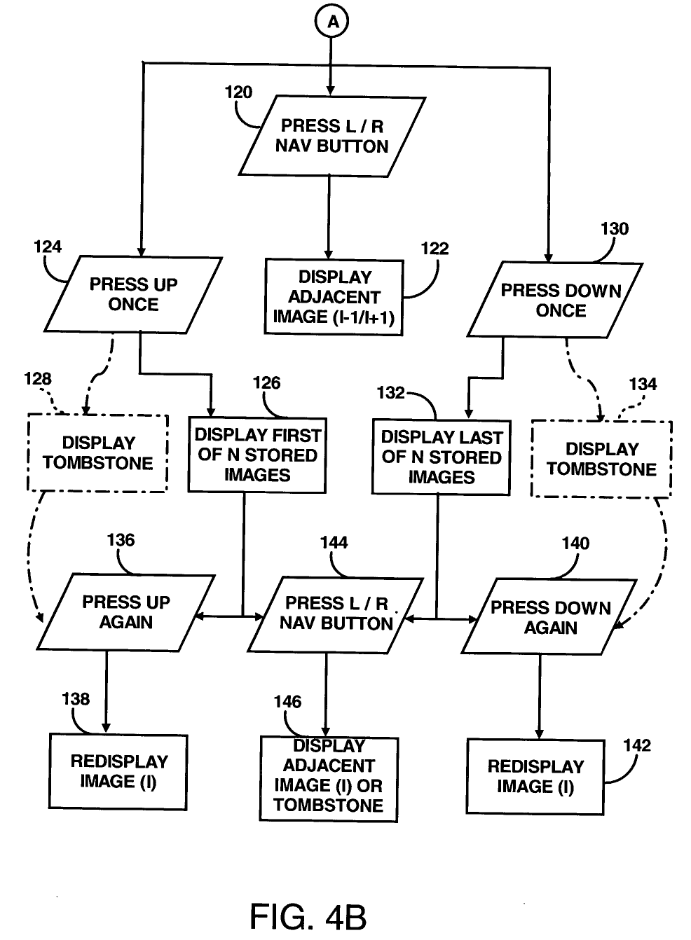

FIGS. 4A and 4B collectively illustrate a method 100 according to an exemplary embodiment of the present invention that may correspond with the organizational memory scheme of FIG. 2 and the digital camera of FIGS. 1 and 3. One of ordinary skill in the art will recognize that the method 100 could be carried out using a variety of different software and hardware and is not limited to the devices described herein. Accordingly, FIG. 4 is a functional flowchart that details a portion of the program code of the digital camera that implements jump instructions to effectuate non-sequential jumping from display of a given digital image to another predetermined digital image stored in memory.

When a user activates or presses the mode button, the program code queries whether review mode is being selected at 110. If not, the navigation buttons are programmed for some purpose such as menu navigation at 112. If so, the program code then queries whether digital images are stored in memory at 114. If not, then the digital camera presents the tombstone on the display at 116. If so, then any given digital image may be presented at 118. The digital image to be displayed may be the most recently captured digital image, a predetermined digital image, the previously reviewed image, and the like.

The left and right navigation buttons of the digital camera are programmed such that when either is depressed at 120, the digital camera presents adjacent image I−1 or I+1 respectively at 122. In contrast, the up and down navigation buttons are programmed such that when either is depressed a certain jump routine within the program code is activated. For example, when the up button is pressed once at 124, the digital camera displays the first of N stored digital images at 126. Alternatively, when the up button is pressed once at 124, the digital camera could display the tombstone image at 128. Similarly, when the down button is pressed once at 130, the digital camera displays the last of N stored digital images at 132. Alternatively, when the down button is pressed once at 130, the digital camera could display the tombstone image at 134. Accordingly, pressing the up or down buttons activates the program code to jump from the currently displayed image to the first, last, or tombstone digital image. Alternatively, it is contemplated that the program code could be written so as to jump to any predetermined stored digital image such as the middle image in the series of stored images or a stored image that is designated by the user.

In another embodiment of the method of the present invention, it is contemplated that pressing the up or down buttons once results in the display of basic meta data (such as the image number, F-stop setting, and aperture setting) and that quickly double-pressing, or double-clicking, the up or down buttons results in the display of advanced meta data (such as a flash guide, focus distance, etc.).

As a visual aid, when the jump routine is activated by pressing the up or down buttons, the camera temporarily displays a textual message over the image that indicates, for example, that the first of N images has just been jumped to from image I. The textual message is displayed briefly, e.g. for a two to three second period of time, and then begins to fade from view. Such a textual message provides context for the user in the event that the user has inadvertently pressed the up or down button. In this way, the digital camera passively, but effectively, “teaches” the user how the camera operates.

Upon displaying the first or last of N stored digital images at 126 or 132 respectively, the user may desire to jump back to the original displayed image. Accordingly, the program code contains instructions for reverting back from a jumped-to image to the original displayed image. Accordingly, when the up button is pressed at 136 the digital camera jumps from the first of N images and redisplays the original displayed digital image at 138. Similarly, when the down button is pressed at 140, the digital camera jumps from the last of N images and redisplays image I at 142. Moreover, if the left or right buttons are pressed at 144, the digital camera displays those digital images that are adjacent to the first or last of N images at 146.

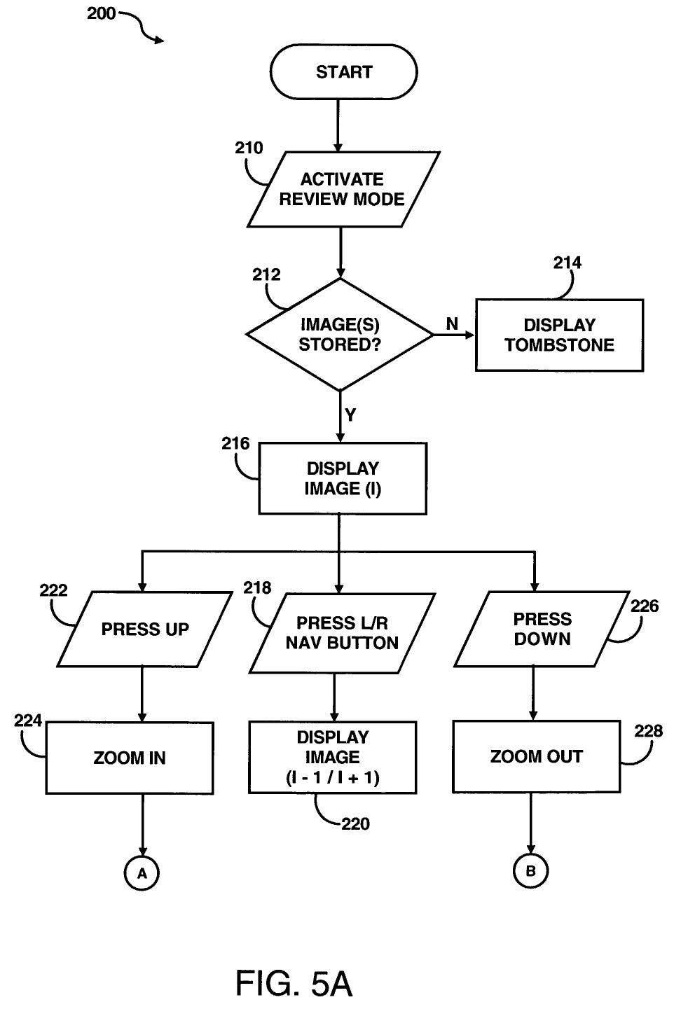

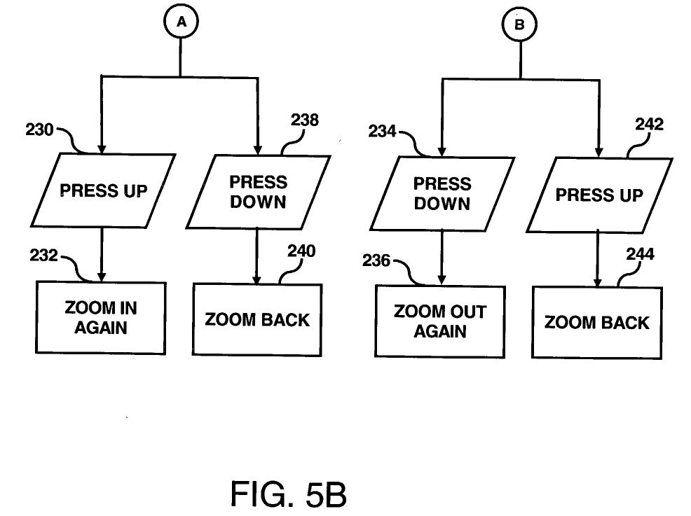

FIGS. 5A and 5B collectively illustrate another method 200 according to another exemplary embodiment of the present invention that corresponds with the organizational memory scheme of FIG. 2 and the digital camera of FIGS. 1 and 3. One of ordinary skill in the art will recognize that the method 200 could be carried out using a variety of different software and hardware and is not limited to the devices described herein. Accordingly, FIGS. 5A and 5B constitute a functional flowchart that details a portion of the program code of the digital camera relating to zoom instructions to effectuate zooming (enlarging or reducing) a given digital image or a portion thereof.

A user may depress the mode button to activate review mode at 210, upon which the program code queries whether a digital image is stored in memory at 212. If not, the digital camera may, for example, display the tombstone image at 214. If so, then any given digital image I may be presented at 216. The digital image I may be the most recently captured digital image, a predetermined digital image, and the like. The left and right navigation buttons are programmed such that when they are depressed at 218, the digital camera presents adjacent image I−1 or I+1 respectively at 220.

In contrast, the up and down navigation buttons are programmed such that when they are depressed, zoom instructions within the program code are activated. For example, when the up button is pressed once at 222, the digital camera zooms in one level or enlarges a portion of the digital image I at 224. Similarly, when the down button is pressed once at 226, the digital camera zooms out one level or reduces the stored digital image I or portions thereof at 228. From the zoom-in step 224, a user may press the up button at 230 to instruct the digital camera to zoom in again at 232. To zoom back from step 224, a user may press the down button at 238 and the digital camera will correspondingly zoom back one level at 240. Similarly, from the zoom-out step 228, a user may press the down button again at 234 to instruct the digital camera to zoom out again at 236. To zoom back from step 228, a user may press the up button at 242 and the digital camera will correspondingly zoom back one level at 244. These steps can be repeated again and again and in any desired combination to the extent of the resolution capability of the digital camera.

Once the zoom mode is invoked by pressing the up or down buttons, pressing the left or right buttons will initiate scrolling functionality within review mode. Accordingly, a user can then use the navigation control to pan across the currently displayed image. To reactivate zoom mode, a user need only press the navigation control straight down to depress the select control button of the five-way rocker switch. Accordingly, a user can again zoom in or out as desired.

Thus, what has been described is a simple apparatus and procedure for navigating among multitudes of stored digital images that is intuitive and user-friendly. Previously, while reviewing individually displayed images, a user had to scroll sequentially from one image, across one or more other images, to the desired image or known position. Using the disclosed apparatus and methodology, with the touch of a navigational control it is possible for a user to jump directly from a given displayed image to a known position or predetermined image, and then with another touch of a navigational control to either revert directly back to the given displayed image or continue scrolling from the jumped-to image. Also disclosed are means by which the navigational control can be pressed to either zoom in or zoom out on the given digital image as a functional enhancement to the navigational control.

What is claimed is:

1. A user interface for a digital camera comprising:
a display for individually displaying a plurality of images; and
a navigational control in communication with said display, said navigational control comprising:
a first pair of opposing directional modes provided for sequentially scrolling through said plurality of images; and
a second pair of opposing directional modes provided for at least one of the following functions:
controlling zoom functionality of said plurality of images; and
jumping non-sequentially from one image of said plurality of images to another image of said plurality of images to display said another image.

2. A method of reviewing stored images on a digital camera, said method comprising:
displaying one image of a plurality of stored images; and
navigating said plurality of stored images, said navigating comprising at least one of the following:
jumping from said one image to another image of said plurality of stored images, whereby said another image is then displayed; and
zooming said one image by activating a pair of opposing directional input controls.

3. An image browsing user interface, comprising:
means for individually displaying one image of a plurality of stored images; and
means for non-sequentially jumping from said one image to display another image of said plurality of images.

4. The image browsing user interface as claimed in claim 3, further comprising:
means for reverting directly back to said one image from said another image, whereby said one image is again displayed.

5. The image browsing user interface as claimed in claim 4, wherein said means for non-sequentially jumping and said means for reverting comprise a rocker switch having two pairs of opposing directional buttons.

6. A digital camera comprising:
an optical system for directing an optical image;
a photosensor for converting said optical image to a converted image;
a memory for receiving said converted image and accumulating a plurality of converted images;
a processor in communication with said memory and said photosensor; and
an output display device in communication with said processor, said output display device for visually presenting said plurality of converted images; and
an input control device in communication with said processor, said input control device for activating review of said plurality of converted images; and
program code stored in said memory and executed by said processor in response to activation of said input control device, said program code comprising scroll instructions to sequentially scroll through said plurality of converted images to display said plurality of converted images in succession, said program code further comprising jump instructions to non-sequentially jump from one converted image of said plurality of converted images to another converted image of said plurality of converted images to display said another converted image.

7. The digital camera as claimed in claim 6, said program code further comprising revert instructions to revert back to and redisplay said one converted image.

8. The digital camera as claimed in claim 6, wherein said input control device comprises a first pair of opposing directional modes and a second pair of opposing directional modes.

9. The digital camera as claimed in claim 8, wherein activation of said first pair of opposing directional modes initiates said first instructions of said program code and further wherein activation of said second pair of opposing directional modes initiates said second instructions of said program code.

10. The digital camera as claimed in claim 9, wherein said input control device comprises a rocker switch having at least four ways of directional functionality.

11. The digital camera as claimed in claim 9, wherein said another converted image comprises the first of said plurality of converted images.

12. The digital camera as claimed in claim 9, wherein said another converted image comprises the last of said plurality of converted images.

13. The digital camera as claimed in claim 9, wherein said another converted image comprises a tombstone image of said plurality of converted images.

14. A method of reviewing stored digital images on a digital camera, said method comprising:
displaying one digital image of a plurality of stored digital images; and
jumping non-sequentially from said one digital image to another digital image to display said another digital image.

15. The method as claimed in claim 14, further comprising:
reverting back to said one digital image from said another digital image, whereby said one digital image is redisplayed.

16. The method as claimed in claim 14, wherein said non-sequentially jumping comprises activating a pair of opposing directional input controls.

17. The method as claimed in claim 16, wherein said activating comprises activating one of an up navigational button and a down navigational button.

18. The method as claimed in claim 17, wherein said activating comprises activating said navigational buttons by pressing a rocker switch having at least four ways of directional functionality.

19. The method as claimed in claim 17, wherein said activating comprises single pressing at least one of said up and down navigational buttons once to yield display of basic meta data and double pressing at least one of said up and down navigational buttons to yield display of advanced meta data.

20. The method as claimed in claim 16, wherein said activating yields temporary display of a textual message over said another digital image.

21. The method as claimed in claim 14, wherein said non-sequentially jumping comprises jumping from said one digital image to at least one of the sequentially first digital image and the sequentially last digital image in said plurality of stored digital images.

22. The method as claimed in claim 21, wherein said sequentially first and last digital images comprise a tombstone digital image.

23. The method as claimed in claim 14, further comprising:
scrolling consecutively through said plurality of stored digital images from said one digital image to a successive digital image of said plurality of stored digital images.

24. A digital camera comprising:
an optical system for directing an optical image;
a photosensor for converting said optical image to a converted image;
a memory for receiving said converted image and accumulating a plurality of converted images;
a processor in communication with said memory and said photosensor; and
an output display device in communication with said processor, said output display device for visually presenting said plurality of converted images; and
an input control device in communication with said processor, said input control device for activating review of said plurality of converted images; and
program code stored in said memory and executed by said processor in response to activation of said input control device, said program code comprising scroll instructions to sequentially scroll through said plurality of converted images to display said plurality of converted images in succession, said program code further comprising zoom instructions to enlarge and reduce at least a portion of said converted image.

25. The digital camera as claimed in claim 24, wherein said input control device comprises a first pair of opposing directional modes and a second pair of opposing directional modes.

26. The digital camera as claimed in claim 25, wherein activation of said first pair of opposing directional modes initiates said first instructions of said program code and further wherein activation of said second pair of opposing directional modes initiates said second instructions of said program code.

27. The digital camera as claimed in claim 24, wherein said input control device is a rocker switch having an up button for activating said zooming instructions to enlarge said at least a portion of said converted image.

28. A method of reviewing images on a digital camera, said method comprising:
displaying one image of a plurality of images;
zooming said one image by activating a pair of opposing directional input controls.

29. The method as claimed in claim 28, wherein said activating comprises activating one of an up navigational button and a down navigational button.

30. The method as claimed in claim 29, wherein said activating comprises activating said navigational buttons by pressing a rocker switch.

31. The method as claimed in claim 30, wherein said zooming comprises at least one of enlarging at least a portion of said one image and reducing at least a portion of said one image.

32. The method as claimed in claim 31, further comprising the of initiating scrolling functionality by pressing one of a right navigational button and a left navigational button.

33. The method as claimed in claim 32, further comprising the of reactivating said zooming by pressing a select button.
